(19) United States
(12) Patent Application Publication
(10) Pub. No.: US 2006/0017236 A1
(43) Pub. Date: Jan. 26, 2006

(54) Method for the production of supporting elements for elastomer seals

(76) Inventor: Ralf Salameh, Gondelsheim (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/186,378

(22) Filed: Jul. 21, 2005

(30) Foreign Application Priority Data
Jul. 21, 2004 (DE) 10 2004 035 285.2

(51) Int. Cl. F16J 15/02

(52) U.S. Cl. 277/650; 277/628; 29/715; 29/828

(57) ABSTRACT

Method for producing a support element for an elastomer seal, in which a base body or segments for a base body are punched out with a pre-determinable geometry from a narrow strip having a width substantially corresponding to the maximal width of the base body or of the corresponding segments.

This invention claims priority to German Patent Application No. 10 2004 035 285.2, filed Jul. 21, 2004.

### BACKGROUND OF THE INVENTION

1. Technical Field

The invention concerns a process for manufacturing a supporting element for an elastomer seal by producing a base body or segments for a base body by punching.

2. Related Art

Seals according to the current state of the art tend to contain metallic supporting elements in form of support frames, which have an elastomer vulcanized onto them or injected around them. These support frames are manufactured in series by a punching process that often results in substantial material waste. Aluminum and steel plates are mostly used as carrier frames for seals. Large free spaces tend to be present in the inner parts of the seal geometries, meaning that these inner areas will inevitably be wasted during the punching process. To avoid this punching waste the frame is frequently divided into several individual segments which are later re-joined during the production of the frames.

A flat gasket that is manufactured in two process steps is described in DE-A 199 22 484, where the first step involves the punching of a metal carrier blank from a metal plate or a metal sheet, said blank comprising area sectors which initially are only separated from each other by a narrow lengthwise opening area. This blank does therefore not yet contain the inner opening area provided in the flat seal. The definitive shape of the flat seal is subsequently obtained by deforming so-called deformable areas within the area sectors in such way that by outward bending of these sectors the metallic carrier is brought to the intended end shape.

DE-C 43 12 629 describes an elastomer gasket for sealing off between the oil sump and the engine block of an internal combustion engine, the gasket comprising a stiffening sheet metal insert embedded in elastomeric material and divided into several segments as well as including compression limiters in the area of the screw passages, whereby the segments incorporate longitudinal segments with offset ends with which they overlap the opposed ends of the adjacent longitudinal segments.

DE-A 197 12 109 deals with a molded rubber seal comprising a plurality of mounting apertures substantially open at the edges for accepting attachment fixtures and a carrier formed by one or more pieces of bent wire and sprayed, at least section-wise, with a rubber material.

### SUMMARY OF THE INVENTION AND ADVANTAGES

The invention addresses the task of providing a process for producing a supporting element for an elastomer seal, which achieves increased material savings compared to supporting elements produced by punching of plates.

The task is solved by punching out the base body or the segments for the base body with a pre-determinable geometry from a narrow strip having a width substantially corresponding to the maximal width of the base body or of the segments.

Contrary to punching processes described in prior art, the process according to this invention utilizes a narrow strip, the width thereof corresponding to the maximal width of the base body or of the segments, and being produced by passing through a series of interlinked, in particular CNC controlled processes. The respective punching processes are advantageously controlled on an individual basis. The holes or sections on the base body or on the segments defined by the hole pattern to be generated for each support frame are created by means of serially interconnected punching processes.

If required, blanks can be punched into the base body or into the respective segment to facilitate the subsequent bending process. If required, the opposing ends of the bent base body or of the combined segments can be joined with the known joining techniques.

It is an object of this invention to provide a procedure to produce a closed or also open supporting element of defined geometry, where required also consisting only of segments, with a minimal amount of punching scrap. The procedure is particularly suitable when the width of the support element is identical throughout and the geometries such as the diameter or other elements are repetitive.

The procedure can be applied to all types of metallic support elements, eventually also to those of other materials such as plastic.

### THE DRAWINGS

The present invention is presented by means of an exemplary embodiment and will be further explained in the following. In the drawings, in which:

FIGS. 1a to 1c illustrate a procedure involved in the production of a frame shaped supporting element from a strip; and

FIG. 2 illustrates a supporting element according to FIG. 1c in a bent condition.

### DETAILED DESCRIPTION

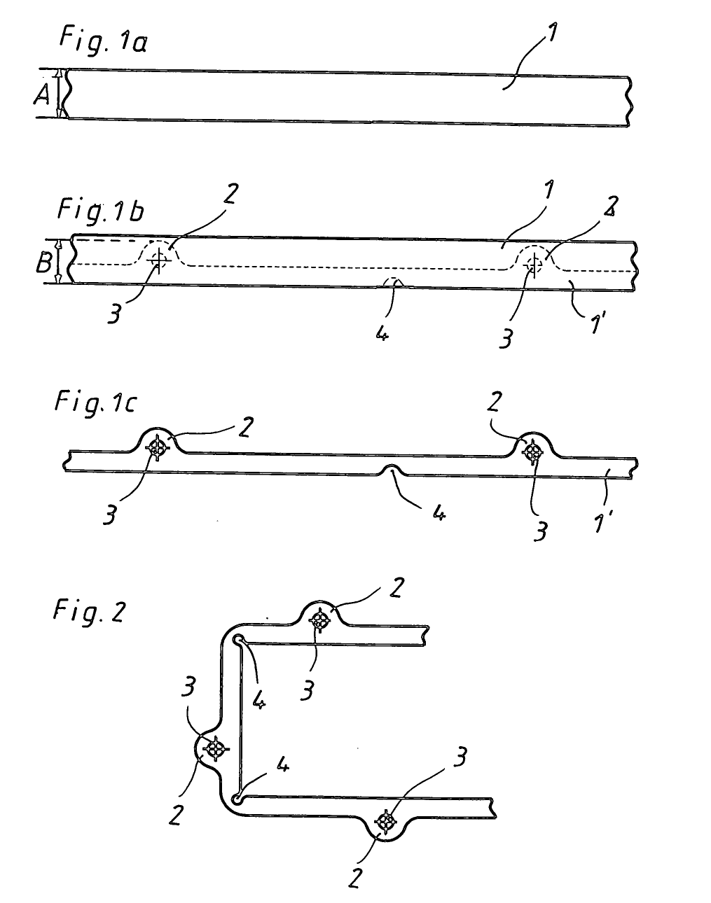

FIGS. 1a to 1c show a metal strip 1, in this case made of aluminum, from which a supporting element is to be produced. According to FIG. 1a the metal strip 1 has the width A. This metal strip 1 is used to punch out a base body 1′ which, according to FIG. 1b, has a base width B and the geometry shown in FIG. 1c. By using a series of interconnected, preferably CNC controlled punching processes it is possible to create the moldings 2 in the first instance and the hole patterns 3 in the second instance. The equation A>B applies, whereby the amount of punching scrap is kept to a low level.

As the requirement may be, it is also possible to punch blanks 4 into pre-determined locations on the metal strip 1 to facilitate the subsequent bending process of the base body 1′.

Depending on the layout of the base body 1′ or of the individual segments used to create a base body 1′ the width A of the strip substantially corresponds to the maximal width of the base body 1′. If moldings 2 need to be considered, than the width is to be adapted accordingly.

FIG. 2 shows the base body 1′, produced out of the metal strip 1 in different punching processes according to FIG. 1. The base body 1′ was bent in the area of the punchings 4 in the way shown. The moldings 2, including the holes 3, are facing outwards. When required, it is also possible to join the here not visible ends of the base body 1′ to each other by means of the known joining techniques. The base body 1′ now constitutes the frame shaped support element for an elastomer seal to be produced.

1. Method for producing a support element for an elastomer seal, in which a base body or segments for a base body are punched out with a pre-determinable geometry from a narrow strip having a width substantially corresponding to the maximal width of the base body or of the corresponding segments.

2. The method of claim 1, including using a coiled strip to produce the base body or the segments of the base body by passing the strip through a series of serially interconnected punching processes.

3. The method of claim 1, wherein the punching processes are controlled by CNC devices.

4. The method of claim 1, wherein the punching processes are individually controlled.

5. The method of claim 1, wherein blanks are punched into the base body or into at least individual segments and the base body or the respective segments are bent into a pre-determined geometrical form.

6. The method of claim 5, wherein the blanks are punched such that opposing ends of the bent base body or those of the segments are connected to each other.

7. The method of claim 1, wherein the base body or the segments are punched out from a continuous strip made of metal or synthetic material.
